(19) United States
(12) Patent Application Publication
(10) Pub. No.: US 2015/0096474 A1
(43) Pub. Date: Apr. 9, 2015

(54) Upper Body Support Apparatus

(71) Applicant: THADDEUS R. HILL, Wilmington, NC (US)

(72) Inventor: THADDEUS R. HILL, Wilmington, NC (US)

(21) Appl. No.: 14/506,669

(22) Filed: Oct. 5, 2014

Related U.S. Application Data
(60) Provisional application No. 61/887,287, filed on Oct. 4, 2013.

(51) Int. Cl. A47K 3/12; F16M 11/24; A47C 16/04; F16M 11/20

(52) U.S. Cl. CPC A47K 3/125; F16M 11/2021; F16M 11/24; A47C 16/04
USPC 108/50.11; 248/158; 248/397; 248/161

(57) ABSTRACT

An apparatus for supporting a person's upper torso while kneeling and leaning forward against another substantially vertical surface while keeping the user's hands free. The device features a horizontal base connected to a rigid, canted support structure that extends up and away from the base to a planar surface. The support structure can be outfitted with a support member to contact the substantially vertical surface and provide further stability. Furthermore, the device can be outfitted with a horizontal tray including a reservoir to store tools and other objects.

### CROSS-REFERENCE TO RELATED APPLICATIONS

This application claims the benefit of U.S. Provisional Application Ser. No. 61/887,287 filed Oct. 4, 2013, which is hereby incorporated by reference in its entirety.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

1. Field of the Invention

The present invention is a device for supporting a human body. More particularly, the present invention is in the technical field of devices designed to support a human body, particularly the upper torso, while leaning forward.

Alternatively, the present invention is in the technical field of devices designed to assist in providing childcare. More particularly, the present invention is a device designed to support a caregiver while bathing a child. Still more particularly, the present invention is a device designed to support a caregiver leaning over the edge of a tub while bathing a child.

2. Background Art

The problem of supporting a person's body weight while in a kneeling position is an old problem with many solutions. For example, the prior art contains many references describing kneeling devices similar to pews one encounters in a church. These kneelers generally solve only the problem of providing a cushioned surface for the user to kneel on connected to another padded surface on which to rest the user's arms and/or hands (see e.g. U.S. Pat. Nos. 1,877,602, 2,069,124, 1,890,815, 2,101,259). Such devices are not designed to support a user's upper torso nor do they allow a user to lean forward putting their center of gravity in front of their knees while keeping their hands free. In short these devices allow a user to more comfortably kneel while praying and are not suitable for use while performing an activity in a bathtub.

In addition the prior art contains a number of devices that are designed to be used in conjunction with a bathtub, rather than being standalone kneelers. However, these devices are made of flexible materials that rest against the side of a tub. In other words, it is the tub that is supporting the user's weight not the device. By way of example, U.S. Pat. No. 5,313,675 to inventor Tinen, U.S. Pat. No. 4,937,897 to inventor Barnabie and U.S. Pat. No. 5,642,535 to inventor Frawley each disclose devices that are made of plastic or other flexible materials that are meant to provide padding for a user that is leaning against the tub itself. These devices do not support the user's upper torso as the user leans forward allowing them to keep their hands free.

In addition, the prior art contains devices with rigid frames that are designed to allow the user to lean on them. However, these devices do not allow the user to lean forward such that their center of gravity is ahead of or forward form the user's knees. For instance, Goodman (U.S. Pat. No. 5,983,418) discloses a rigid structure with a kneeling surface, a sitting surface and an arm rest. The support structure that connects the lower portion of the device to the upper portion of the device is rigid, but is not canted or angled to allow a user to lean forward and rest their weight such that their center of gravity is further forward than their knees. It is important to note this device anticipates the user will sit on the device and has a resting place for the user's knees.

Todd (U.S. Patent Application Publication Number 2008/0022448 A1) is another example of a device with a rigid support that connects to a surface against the top of which the user can lean of rest their arms. Todd even discloses a block of material that contacts the tub or other surface against which the structure leans. However, the Todd device does not have a canted or angled support structure connecting the base to the platform, i.e. the device is meant to sit next to and contact a surface like a tub. Because the support structure is vertical it limits the ability of the user to position their center of gravity forward past their knees.

### BRIEF SUMMARY OF THE INVENTION

The inventor conceived of the present invention while bathing a child in a standard household bathtub. During the bathing process, a user is usually in a kneeling or sitting position in front of or on the exterior of the bathtub and has to lean their body over the exterior lip of the bathtub in order to complete such a task. Leaning or suspending the user's body over the lip of the bathtub requires the user to use at least one of their hands to support some or all of the user's body weight to maintain balance and/or avoid injury, particularly to the user's lower back. As a result, bathing a child becomes a dreaded and uncomfortable undertaking for the parent.

The present invention may be readily applied to any circumstance or undertaking in which a person needs to keep their hands free while kneeling and leaning forward, including without limitation the tasks of bathing a child or pet or cleaning paintbrushes.

The present invention is a body supporting apparatus for use in association with a bathtub that reduces body fatigue and supports the upper torso of a user leaning over and above the edge of a bathtub allowing the user to keep their hands free. Although it is anticipated the invention will be used by people leaning over and above the edge of a bathtub for any of a variety of purposes, the inventor further contemplates that the device may have particularized use in any context in which a kneeling person may be in need of upper torso support while retaining a full range of motion and use of both arms and hands.

In its broadest embodiment, the inventive support apparatus comprises a horizontal base, a rigid and canted support structure connected to the horizontal base and extending upward and away from one edge of the horizontal base, and a canted and flat planar surface positioned at the apex of the canted support structure. A discussion of the contemplated use of the broadest embodiment will illustrate the anticipated use of all embodiments of the invention. The device is designed such that a user kneels upon the horizontal base with the canted support structure extending upward directly in front of the user's kneecaps. The user then leans forward resting their upper torso against the canted and flat planar surface. This design supports the weight of the user and allows them to keep both of their hands free without need for the user to grasp or embrace any structure for further support. In use, the device may be propped against any sturdy horizontal edge at any point along the canted support structure on the face of the support structure opposite the canted and flat planar surface. As presently conceived, a significant inventive departure is believed to be, in combination, (i) a lack of any further physical component (e.g., a support leg or suspension cable) to support the self-contained apparatus when in use, and (ii) intrinsic support of the self-contained apparatus when in use by the counterbalancing of a user's body weight exerted upon the horizontal base and the torque generated by the user's upper torso leaning against the canted and flat planar surface at the apex of the support structure. The device may be additionally supported by propping the device against any sturdy horizontal edge—the point of contact with such an edge being on the face of the support structure opposite the face featuring the canted and flat planar surface.

In a preferred embodiment, the horizontal base is a padded or cushioned surface whereupon a user may kneel, thus providing comfort to the user's knees where the knees directly contact the horizontal base. Likewise, a further preferred embodiment contemplates that the canted and flat planar surface at or near the apex of the support structure is also a padded or cushioned surface whereupon a user may rest the weight of their upper torso during use. In the case of both the padded horizontal base and the padded canted and flat surface, the inventor contemplates that the padding or cushions may be removable and interchangeable on the device, thus allowing for easy cleaning of the cushions and the device and/or easy replacement of the cushions upon substantial wear and tear. Particularly in the case of the padded, canted and flat surface, the inventor further contemplates that the padding should be ergonomically appropriate to readily support the upper torso of either a male or female user, the padding being either shaped so as not to interfere with the breasts of a female user or the entire canted and flat surface being capable of rotating between two varying configurations—a first configuration appropriate for a male user and a second configuration appropriate for a female user minimizing interference of the pad and surface with the female user's breasts.

In a further preferred embodiment, the face of the support structure opposite the canted and planar surface may be outfitted with a support member at a point along the length of the support structure, the support member comprising an outward-facing and slip-resistant surface and means whereby the plane of the slip-resistant surface may be adjusted by the user. In use, the support member stabilizes the device by providing a slip-resistant surface against the side or edge of a rigid structure against which the device is rested such as a bathtub.

In a still further preferred embodiment, the face of the support structure opposite the canted and planar surface may be outfitted with at least one horizontal tray extending outward from the support structure and designed to allow the user to store items, including without limitation soap, shampoo, sponges, tools or other useful implementsduring use. By way of illustration, in the case of a user utilizing the device while bathing a child, pet, or disabled person in a standard bathtub, the tray or trays, as the case may be, may serve to hold soap, shampoo, conditioner, sponges, etc., thereby allowing the user to keep their hands free and the items within easy reach.

In a still further preferred embodiment, the rigid and canted support structure would be constructed in such way as to be extendable, thereby allowing a single unit of the invention to serve a short or tall person with equal effectiveness.

### BRIEF DESCRIPTION OF THE SEVERAL VIEWS OF THE DRAWING

FIG. 1 is a perspective view of the side of the conceived best mode of the present invention with the planar surface in a first configuration;

FIG. 2 is a side plan view of the conceived best mode of the present invention; and

FIG. 3 is a perspective side view of the conceived best mode of the present invention with the planar surface in a second configuration.

### DETAILED DESCRIPTION OF THE INVENTION

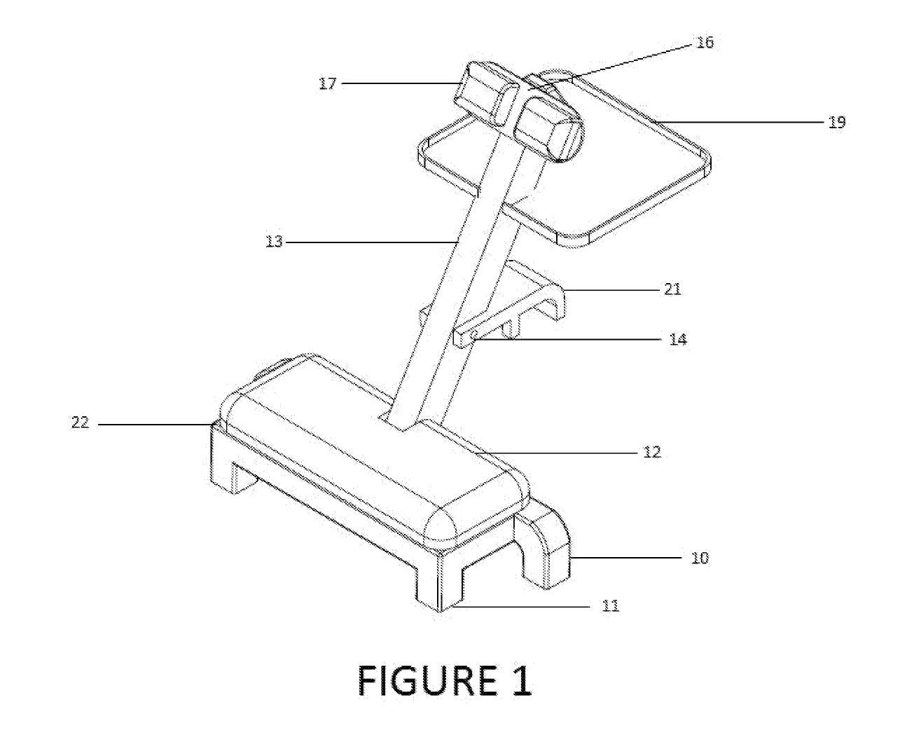

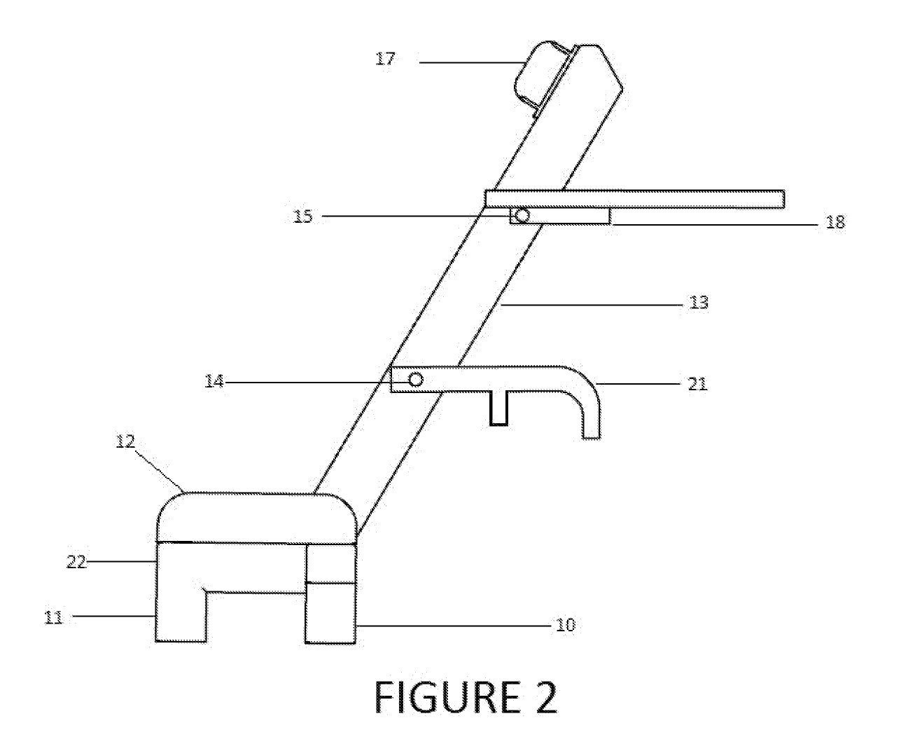

Referring now to the invention in more detail, in FIG. 1 there is shown a perspective side view of the conceived best mode of the present inventive device. Specifically, there is depicted a horizontal base 22, a rigid and canted support structure 13 connected to the horizontal base 22 and extending upward and away from one edge of the horizontal base 22, and a canted and flat planar surface 16 positioned at the apex of the canted support structure 13. There is further depicted a front footing 10 and a rear footing 11 affixed to the bottom of the horizontal base 22 and serving to support the horizontal base 22 at a fixed distance above a floor surface or ground. Along the length of the rigid and canted support structure 13, there is a first hinge joint 14 at the point of attachment of a support member 21 and a second hinge joint 15 (see FIG. 2) at the point of attachment of a support arm 18 supporting a horizontal tray 19. The support member 21 attached to the rigid and canted structure 13 at the first hinge joint 15 is designed to have an outward facing slip-resistant surface that, when placed in contact with the side or edge of a rigid structure such as the exterior side or lip of a bathtub serves to further support the device. The support arm 18 and horizontal tray 19 attached to the rigid and canted support structure 13 extend outward from the axis of the support structure 13. The horizontal base 22 is equipped with a cushion system 12 to provide comfort to the user's knees and the canted and flat planar surface 16 is similarly equipped with a padding system 17 to provide comfort to the user's upper torso.

In more detail, still referring to the invention of FIG. 1, the best mode of the device, as shown, facilitates a user comfortably bathing a child, pet or invalid person in a bathtub. The user positions the user's kneecaps on the cushion system 12 affixed to the horizontal base 22 in such way that the chest of the user is facing the rigid and canted support structure. The user may then lean forward, positioning the user's upper chest flush against the padding system 17 affixed to the canted and flat planar surface 16, such that the user is kneeling upon the horizontal base 22 with the user's remaining body weight pressing against and supported by the canted and flat planar surface 16. In addition, the device may be positioned adjacent to a bathtub or similar structure. Then the support member 21, attached to the rigid and canted structure 13 at the first hinge joint 15, may be rotated about the first hinge joint 15 so as to position the support member 21 flush against the exterior side or lip of the bathtub. Doing so adds additional support and stability to that already created by the counterbalance of the user's weight upon the horizontal base 22 against the torque generated by the user's upper torso resting upon the canted and flat planar surface 16 at the opposite end of the rigid and canted support structure 13.

In addition, the user can manually adjust the second hinge joint 15 so as to reposition the tray 19 for the convenience of the user. In the best mode it is contemplated that the tray 19 would be of sufficient surface area as to readily hold any number of items that the user may require to complete the task at hand—perhaps tools in a construction project context or perhaps soap and shampoo in a bathing context. Just as the tray 19 is contemplated as a storage component during use of the device, the tray may also be outfitted with any number of utility features common and useful to a staging surface for bathing use, including without limitation a reservoir, soap dish, shower caddy, sponge holding compartment, etc.

The components of the contemplated best mode are to be constructed from durable materials capable of sustaining frequent and prolonged usage. Specifically, the horizontal base 22 is contemplated to be constructed of any rigid and durable material including without limitation wood, aluminum, steel, other metals, and/or rigid plastics. The front footing 10 and rear footing 11 of the horizontal base are contemplated to be constructed of a substantially slip-resistant material. The cushion system 12 of the horizontal base 22 may be constructed of foam or a thin fabric casing containing a soft and displaceable material such as a gel, cotton, or fine grain sand. The rigid and canted support system 13, support member 21, support arm 18, tray 19, reservoir 20, and canted and flat planar surface are also contemplated to be constructed of any rigid and durable material including without limitation, wood, aluminum, steel, other metals, and/or rigid plastics. As with the horizontal base 22 cushion system 12, the canted and flat planar surface is equipped with a padding system 17 that may be constructed of foam or a thin fabric casing containing a soft and displaceable material such as a gel, cotton, or fine grain sand. Due to the nature of the device, the length of the rigid and canted support structure 13 should never be shorter in length than two feet, nor longer in length than five feet—this range of lengths is contemplated to make the device accessible for all human users and approximates the range of distances that varying humans may have between their kneecaps and shoulders.

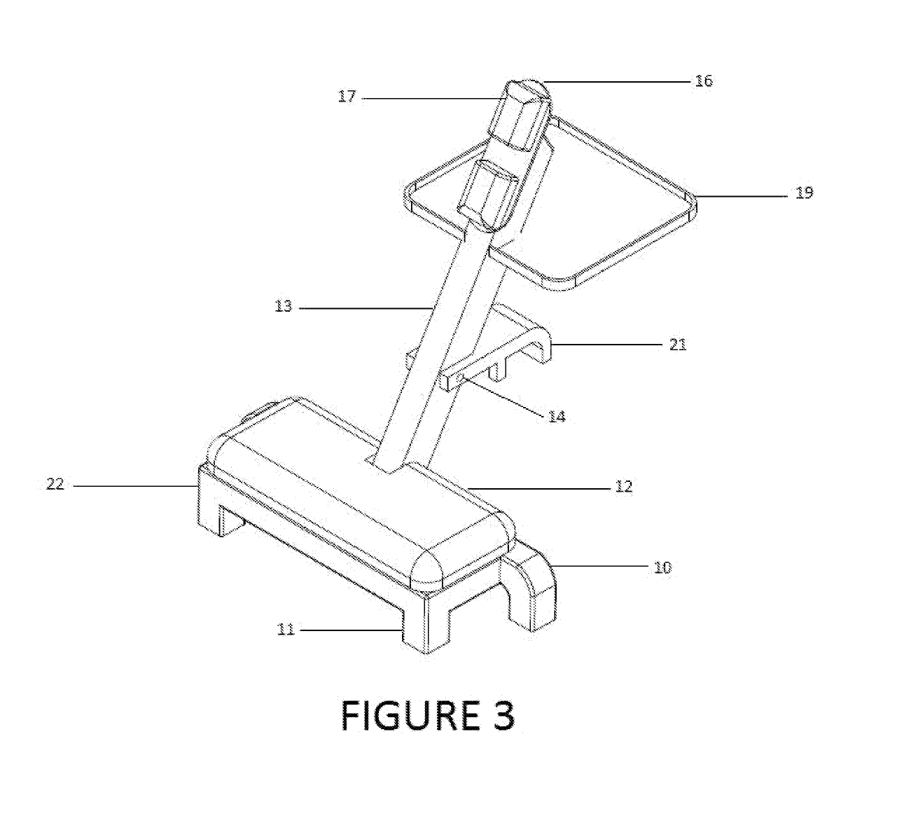

Referring now to the invention in more detail, in FIGS. 2 and 3 show additional side views of the conceived best mode of the present inventive device. Specifically, there is depicted a horizontal base 22, a rigid and canted support structure 13 connected to the horizontal base 22 and extending upward and away from one edge of the horizontal base 22, and a canted and flat planar surface 16 positioned at the apex of the canted support structure 13. There is further depicted a front footing 10 and a rear footing 11 affixed to the bottom of the horizontal base 22 and serving to support the horizontal base 22 at a fixed distance above a floor surface or ground. Along the length of the rigid and canted support structure 13, there is a first hinge joint 14 at the point of attachment of a support member 21 and a second hinge joint 15 at the point of attachment of a support arm 18 supporting a horizontal tray 19. The support member 21 attached to the rigid and canted structure 13 at the first hinge joint 15 is designed to have an outward facing slip-resistant surface that, when placed in contact with the exterior side or lip of a bathtub or the like serves to further support the device. The support arm 18 and horizontal tray 19 attached to the rigid and canted support structure 13 extend outward from the axis of the support structure 13. The tray 19 may also be outfitted with any number of utility features common and useful to a staging surface for bathing use, including without limitation a reservoir, soap dish, shower caddy, sponge holding compartment, etc.. The horizontal base 22 is equipped with a cushion system 12 to provide comfort to a user's knees, and the canted and flat planar surface 16 is similarly equipped with a padding system 17 to provide comfort to a user's upper torso.

Reference throughout the specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout the specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

It is understood that the above described embodiments are only illustrative of the application of the principles of the present invention. The present invention may be embodied in other specific forms without departing from its spirit or essential characteristics. The described embodiment, including the best mode, is to be considered in all respects only as illustrative and not restrictive. The scope of the invention is, therefore, indicated by the appended claims, if any, in conjunction with the foregoing description.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

What is claimed is:

1. An apparatus for supporting a person's upper torso while kneeling and leaning forward, the apparatus comprising:
a horizontal base,
a planar surface, and
a rigid, canted support structure having a first end and a second end,
the support structure being connected at the first end to the horizontal base and extending vertically from the base at an incline so as to create an obtuse angle between the plane of the horizontal base and the plane of the support structure, and
the support structure attached at the second end to the planar surface.

2. The apparatus of claim 1 wherein at least one of the pair consisting of the horizontal base and the planar surface is cushioned.

3. The apparatus of claim 2 wherein at least one of the pair consisting of the horizontal base and the planar surface has removable cushioning.

4. The apparatus of claim 1 wherein the planar surface is capable of rotating between at least two varying configurations.

5. The apparatus of claim 1 wherein the support structure further comprises a support member at a point on the face of the support structure opposite the horizontal base and planar surface, the support member being positioned on the opposite face of the support structure at a point between the horizontal base and the planar surface.

6. The apparatus of claim 1 wherein a face of the support structure opposite the planar surface features at least one horizontal tray extending outward from the support structure.

7. The apparatus of claim 3 wherein the planar surface is capable of rotating between at least two varying configurations.

8. The apparatus of claim 7 wherein the support structure features means whereby its length may be adjusted.

9. The apparatus of claim 8 wherein a face of the support structure opposite the planar surface features at least one horizontal tray extending outward from the support structure.

10. The apparatus of claim 9 wherein the planar surface comprises an upper section and a lower section, each of the sections being between 3″ and 10″ in width, and a central section connecting the upper section to the lower section, the central section being 3″ or less in width.

11. The apparatus of claim 10 wherein the support structure further comprises a support member at a point on the face of the support structure opposite the horizontal base and planar surface, the support member being positioned on the opposite face of the support structure at a point between the horizontal base and the planar surface.

12. The apparatus of claim 8 wherein the planar surface comprises an upper section and a lower section, each section being between 3″ and 10″ in width, and a central section connecting the upper sectionto the lower section, the central section being 3″ or less in width.

13. The apparatus of claim 8 wherein the support structure further comprises a support member at a point on the face of the support structure opposite the horizontal base and planar surface, the support member being positioned on the opposite face of the support structure at a point between the horizontal base and the planar surface.

14. The apparatus of claim 13 wherein a face of the support structure opposite the planar surface features at least one horizontal tray extending outward from the support structure.

15. The apparatus of claim 13 wherein the planar surface comprises an upper section and a lower section, each of the sections being between 3″ and 10″ in width, and a central section connecting the upper section to the lower section, the central section being 3″ or less in width.

16. The apparatus of claim 1 wherein the support structure features means whereby its length may be adjusted.

17. The apparatus of claim 1 wherein the planar surface is ergonomically designed to support a female user via contact and support of the user's sternum while minimalizing contact and interference with the user's breasts.

18. The apparatus of claim 17 wherein the planar surface comprises an upper section and a lower section, each section being between 3″ and 10″ in width, and a central section connecting the upper section to the lower section, the central section being 3″ or less in width.

19. An apparatus for supporting a person's upper torso while leaning over a tub, the apparatus comprising:
a cushioned and removable horizontal base,
a cushioned and removable planar surface comprising an upper section and a lower section, each section being between 3″ and 10″ in width, and a central section connecting the upper section to the lower section, the central section being 3″ or less in width,
a rigid, canted support structure having a first end and a second end, connected at the first end to the horizontal base, at the second end to the planar surface, and capable of being leaned against a side of a tub,
a horizontal tray extending outward from the support structure,
a support member at a point on the face of the support structure opposite the horizontal base and planar surface, the support member being positioned on the opposite face of the support structure at a point between the horizontal base and the planar surface,
means whereby the planar surface is capable of rotating between at least two varying configurations, and
means whereby the length of the support structure may be adjusted.

20. The apparatus of claim 1 wherein at least one of the pair consisting of the horizontal base and the planar surface has removable cushioning.
